(19) United States
(12) Patent Application Publication
(10) Pub. No.: US 2007/0137632 A1
(43) Pub. Date: Jun. 21, 2007

(54) Closure for cables

(76) Inventors: Andreas Steiner, TIEFENGRABEN (AT); Wolfgang Winkler, Thalgau (AT)

Correspondence Address: MCGLEW & TUTTLE, PC, P.O. BOX 9227, SCARBOROUGH STATION, SCARBOROUGH, NY, 10510-9227, US

(21) Appl. No.: 10/595,664

(22) PCT Filed: Nov. 3, 2004
(86) PCT No.: PCT/EP04/12431

§ 371 Date: May 3, 2006

(30) Foreign Application Priority Data
Nov. 5, 2003 (DE) 203 17 186.1

(51) Int. Cl. B28D 1/08

(52) U.S. Cl. 125/21

(57) ABSTRACT

The invention relates to a closure and a method for connecting and opening saw cables (1), whereby the closure (4) is made up of several parts, which may be connected to each other, such as to rotate about at least two separate axes, by means of several bearings (13, 26, 27). The closure comprises two closure pieces (5, 6) with a separable rotating bearing (13) and a bearing lock (18) which may be opened, depending on the angular position of the closure pieces.

### CROSS REFERENCE TO RELATED APPLICATIONS

This application is a United States National Phase application of International Application PCT//EP2004/012431 and claims the benefit of priority under 35 U.S.C. §119 of German Utility model 203 17 186.1 filed Nov. 5, 2003, the entire contents of which are incorporated herein by reference.

### FIELD OF THE INVENTION

The present invention pertains to a closure for cables, especially cable saws, and to a process for connecting and opening cables wherein the closure comprises a plurality of parts, which can be connected to one another movably about at least two separate axes by means of a plurality of bearings

### BACKGROUND OF THE INVENTION

Such a closure is known from EP 0 680 395 B1. It is used to connect the cable ends of a cable saw and comprises three parts, which are designed in the manner of a cardan joint and are connected to one another by means of two bearings about two separate axes. Due to the cardan-like design and the two axes that cross each other, the closure is flexible and can follow the variable bendings of the cable. The prior-art closure comprises two end-side fork pieces and an intermediate piece, which are rotatably connected to one another by bearing pins. To open the closure, one bearing pin must be loosened and removed. This is possible by the use of a stud, which does, however, have the drawback that a screwdriver is necessary and that, moreover, the stud requires continuous checking and maintenance to prevent it from loosening by itself during the operation of the cable. This is a problem in terms of safety and accidents.

A similar cardanic closure is also known from FR 1 357 117, where this closure cannot, however, be opened without being damaged.

Another closure in the form of a spherical closure is known from CH 8544. Such spherical closures have multiaxial ball bearings, and the parts of the closure can rotate relative to one another in a plurality of directions because of the spherical shape. The angles of rotation are, however, greatly limited. Such spherical closures have, moreover, a certain axial mobility and are subject to increased wear.

### SUMMARY OF THE INVENTION

The object of the present invention is to provide an improved closure for cables.

The present invention accomplishes this object with the features that the closure has the advantage that the closure can be opened and closed easily and simply thanks to the separable pivot bearing between the closure parts and the bearing securing means, which can be loosened in an angle-dependent manner. The bearing securing means is reliably closed in the operating positions of the cable, which is brought about simply by mutually rotating the closure parts.

The pivot bearing is preferably designed here as a plug-type bearing, especially as a pivot bearing, which has a defined axis of rotation, which offers optimal guiding for the force transmission between the closure parts at right angles to the axis of rotation. Axial mobilities, as they occur in spherical closures, are ruled out as a result. The bearing securing means acts in the longitudinal direction of the axis of rotation and reliably holds together as a result the closure parts and the pivot bearing in all stretched and bent operating positions of the closure.

The embodiment of the bearing securing means as a rotatable tongue-and-groove guide has the advantage that it is automatically closed during the rotation of the closure parts in relation to one another. Additional components or kinematics are not necessary. The embodiment being claimed is especially safe and reliable. Due to the rotatability, the guide can follow the different rotated positions of the closure parts during the operation of the cable, and securing of the bearing is always preserved in the direction of the axis of rotation. The tongue-and-groove guide may be present as a single guide or as a double guide in an optimized embodiment. In this variant, it is arranged on two opposite sides of the axis of rotation and at a spaced location from the axis of rotation, so that all overturning moments can also be absorbed by this guide while the pivot bearing is relieved.

In the embodiment being claimed, the tongue-and-groove guide can be loosened in a defined loosening position only with a bending angle of about 90° between the closure parts. Such a bent position is not reached during the normal operation of the cable. In addition, opening of the closure is possible only by moving apart the closure parts in a defined manner in a direction directed along the axis of rotation. This likewise prevents the closure from being able to be opened during the normal operation of the cable.

It is especially favorable for the closure and bearing kinematics if the closure parts touch each other on a bearing surface only and both are traversed here by the bearing pin transversely, wherein the collar forming the tongue directly adjoins the bearing surface. On the other side, the bearing surface passes over into the groove. In case of a double tongue-and-groove guide, both closure parts may be essentially of identical design, which makes it simple and less expensive to manufacture them. The bearing securing means acts directly between the closure parts in this embodiment while the bearing pin is relieved and at a spaced location from the axis of rotation. Due to the formation of a step at the collar and the offset of the groove, the permissible operating angles between the closure parts may be very great, and the loosened position can be assumed in the extreme end position only. There is a sufficiently large overlap between the walls of the groove and the collar in all operating positions of the cable and of the closure due to the essentially concentric bending or curvature of the collar and of the groove. This guarantees reliable force transmission and blocking function of the bearing securing means in all rotated and bent positions of the closure that are permissible during the operation of the cable.

In the preferred embodiment, the closure comprises four parts and has a multiple joint with a cardan-like arrangement of three or more defined axes of rotation or pivoting. This offers especially good closure kinematics.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a side view showing a multipart closure for a cable in the stretched position;

FIG. 2 is a top view of the closure of FIG. 1;

FIG. 3 is a view of different angular positions of the closure parts from the arrangement of FIG. 2;

FIG. 4 is a top view of an individual closure part;

FIG. 5 is a tilted side view of the closure part of FIG. 4;

FIG. 6 is a lengthwise cut top view of the closure part according to FIG. 4;

FIG. 7 is a longitudinal sectional view taken through the closure part according to section line VII-VII in FIG. 4;

FIG. 8 is a front view of the closure part according to FIG. 7, which is tilted upward;

FIG. 9 is a front view of the closure part according to FIG. 7, which is tilted downward;

FIG. 10 is a tilted bottom view of the closure part of FIG. 7;

FIG. 11 is a perspective front view of a closure part; and

FIG. 12 is a perspective top view of two closure parts in the loosened position.

### DESCRIPTION OF THE PREFERRED EMBODIMENT

Referring to the drawings in particular, the present invention pertains to an articulated closure (4) for a cable (1), preferably a saw cable, and to a process for opening and closing such a cable (1) or for connecting a plurality of cables (1). Such saw cables comprise a cable line or a core with a plurality of cutting beads made of a suitable abrasive material, e.g., diamond segments, which beads are arranged distributed axially at spaced locations from one another. Such a saw cable (1) is used to cut walls made of a hard material, e.g., concrete or stone. The saw cable (1) is elastic and forms, e.g., a closed loop, where the two cable ends (2, 3) are connected to one another by the closure (4). As an alternative, a plurality of cables (1) may be connected to one another by means of a plurality of closures (4), in which case an open cable line of any desired length or, in turn, a closed cable loop of likewise any desired length is formed. The closed saw cable (1) is set into circulating motion by means of a cable saw and cuts the workpiece in the process. The articulated closure (4) has essentially the same bending elasticity as the cable (1) and can thus be led over drive and deflecting rollers as well as over edges of the workpiece. As an alternative, the cable (1) may have any other desired design and be used for any other desired purpose, e.g., as a towing or lifting cable.

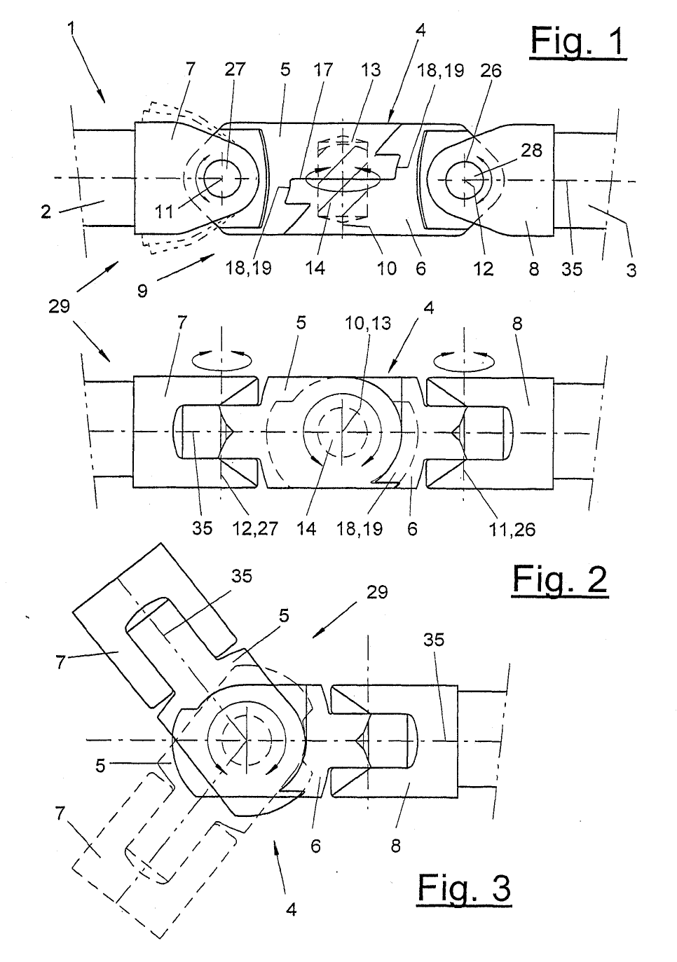

FIGS. 1 through 3 show the closure (4) in the closed operating position (29). FIGS. 1 and 2 illustrate a stretched position, while FIG. 3 shows different operating angles, which may also be greater than those in the drawing.

FIG. 12 shows the closure in a loosened position (30), in which it can be opened without the use of a tool. The opened cable (1) can then be brought into a desired operating position, and it can be threaded, for example, via different deflecting rollers into a cable saw machine and into guides present there. In addition, the opened cable (1) can be pushed or pulled through openings or channels. A saw cable (1) may be passed, e.g., through holes on the workpiece. When the cable (1) has been brought into the desired operating position, the cable ends (2, 3) can again be connected to one another and the closure (4) can be brought into the closed operating position (29).

In the embodiment being shown, the closure (4) comprises four parts and has a multiple joint (9), which is preferably designed as a triple joint. The triple joint (9) has three defined axes (10, 11, 12) for rotary and pivoting motions of the parts (5, 6, 7, 8) of the closure (4). The closure (4) comprises, on the one hand, two closure parts (5, 6), which will hereinafter be called rotary parts, and which are or can be rotatably and separably connected to one another via a common pivot bearing (13). The connecting pivot bearing (13) is arranged between the closure parts (5, 6). Each rotary part (5, 6) is connected at its respective rear end, via a drag bearing (26, 27) each, to another closure part (7, 8), to which a cable end (2, 3) each is attached at the end. The pivot axes (11, 12) of the drag bearings (26, 27) and the bearing pins (28) thereof are directed in parallel and extend at right angles to the axis of rotation (10) of the pivot bearing (13). FIGS. 1 and 2 show the possibilities of rotation of the closure parts or pivoting parts (7, 8), which are preferably designed as a fork head, in relation to the rotary parts (5, 6) by arrows and by views drawn in broken line.

The closure (4) may be opened and closed in the area of the rotary parts (5, 6) and the connecting pivot bearing (13). The closure (4) has, for this purpose, a bearing securing means (18), which can be loosened as a function of the angular position of the rotary parts (5, 6). The bearing securing means (18) is closed and prevents the opening of the closure (4) and of the connecting pivot bearing (13) in the stretched operating positions (29) shown in FIGS. 1 and 2 as well as in the bent operating positions (29) shown in FIG. 3. The closure (4) can be opened and closed only in the loosened position (30) shown in FIG. 12 with an approximately 90° bending angle of the closure parts (5, 6).

The pivot bearing (13) is preferably designed as a plug-type bearing and permits the plugging together of the rotary parts (5, 6). The plug-type bearing is preferably designed constructively as a pivot bearing. It is formed by two flat bearing surfaces (17) of the two rotary parts (5, 6), which the bearing surfaces are flatly in contact with one another in the closed position, as well as by a bearing pin (14), which passes through the bearing surfaces (17) in the transverse direction, with a longitudinally directed axis of rotation (10). The bearing pin (14) may be fastened in one rotary part (6) in a pin mount (15), for example, a blind hole, with clamped connection or by means of a bonded connection, and it engages, with a sufficient bearing clearance, an opposite, aligned bearing opening (16), preferably likewise a blind hole, in the other rotary part (5). As an alternative, the bearing pin (15) may also be loose and plugged into the holes (15, 16) when needed and then fixed in a suitable manner.

With the bearing securing means (18) opened, the rotary parts (5, 6) can be plugged together by means of the bearing pins (14) and in the direction of the axis of rotation (10) to close the closure (4) and moved apart for opening. The bearing pin (14) engages the bearing opening (16) in a positive-locking manner in the closed position and prevents the rotary parts (5, 6) from being pulled apart along the bearing surfaces (17).

The bearing securing means (18) is designed as a rotatable mutual tongue-and-groove guide (19) at the closure parts (5, 6). It is preferably present as a double bearing securing means, with each of the rotary parts (5, 6) having a groove and tongue. Both rotary parts (5, 6) may have essentially an identical design in this embodiment, aside from the arrangement of the bearing pin. The tongue-and-groove guide (19) is curved about the axis (10) of the pivot bearing (13), and this curvature is preferably essentially concentric. Deviating curvatures may be present in some of the areas.

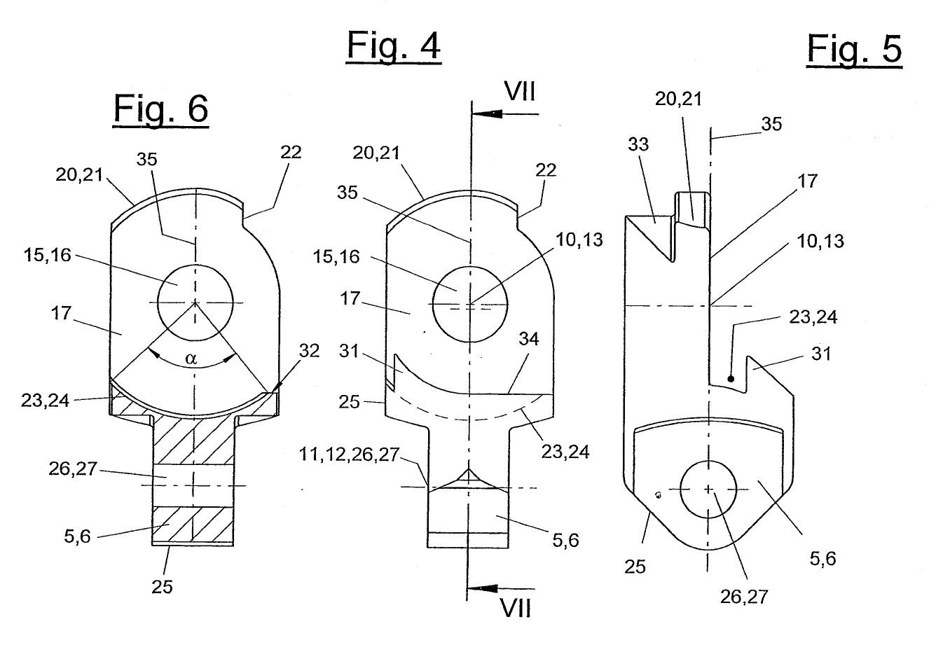

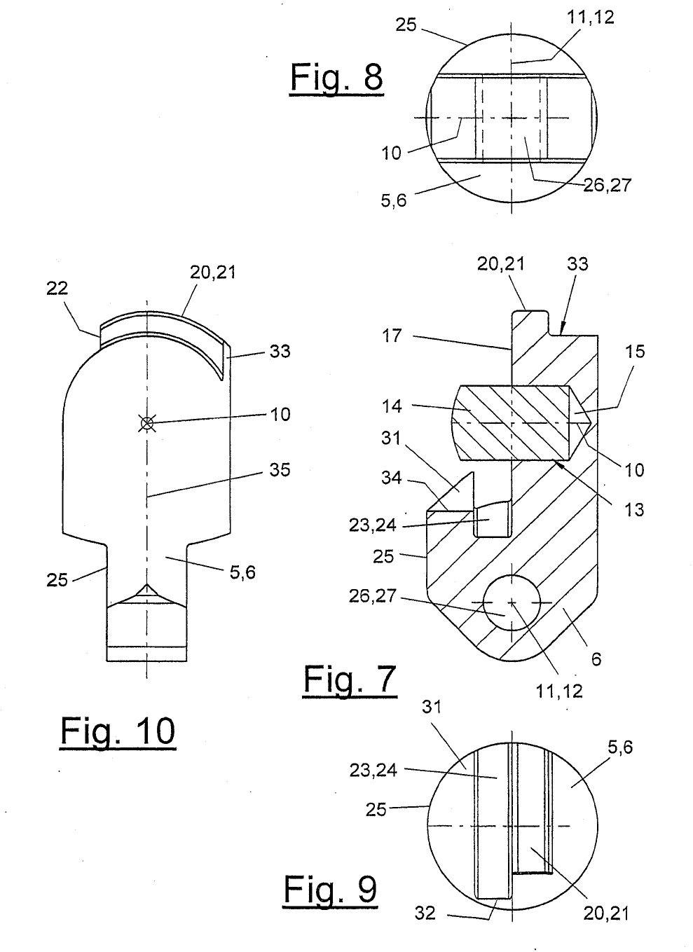

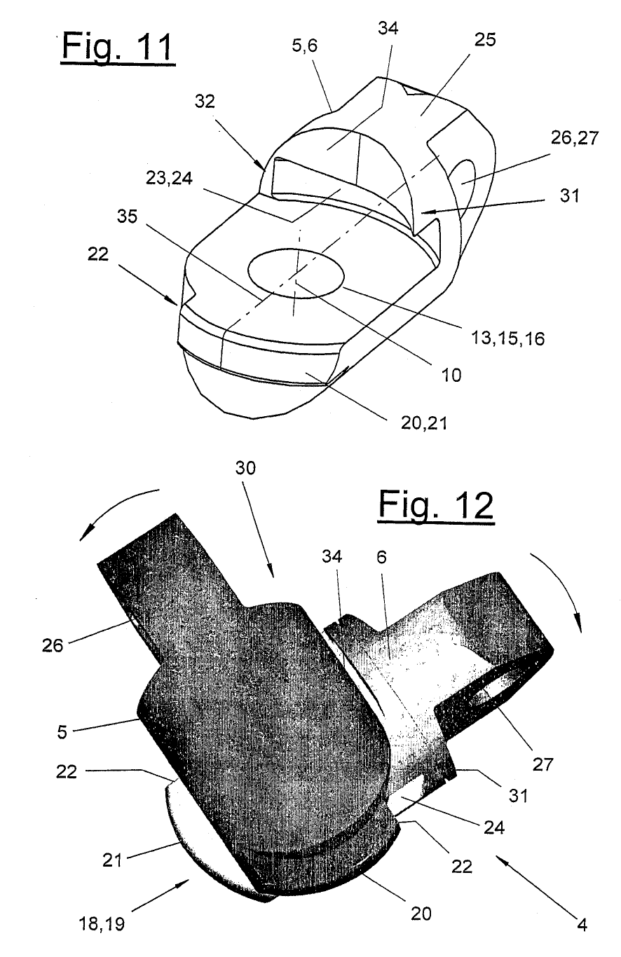

The closure parts or rotary parts (5, 6) are shown in detail in FIGS. 4 through 11. The rotary parts (5, 6) have a stepped body (25) each. Due to the formation of a step, the flat bearing surface (17) is exposed preferably in the horizontal central plane or central longitudinal axis (35). The pivot axis (11, 12) for the connection of the fork head (7, 8) is preferably also located in this plane. The holes (15, 16) are seated centrally in the bearing surface (17).

A projecting, bent collar (20, 21), which forms the tongue for the tongue-and-groove guide (19), is arranged at the free front edge of the bearing surface (17). The bearing surface (17) passes flush over into the top side of the collar (20, 21). The collar (20, 21) has a thickness or height corresponding to the groove (23, 24), which will be explained below. To form the collar (20, 21), the body (25) is set back somewhat beneath the bearing surface (17). A notch (33) may be additionally present at the edge.

A bent groove (23, 24), whose underside passes flush over into the bearing surface (17), is arranged on the rearward side of the bearing surface (17), which side points toward the drag bearing (26, 27). The groove (23, 24) is formed in the step-like elevation of the body (25). The groove (23, 24) and the collar (20, 21) extend at right angles to the longitudinal axis (35) of the rotary part (5, 6) and are located diametrically opposite each other in relation to the axis of rotation (10). The outer wall of the collar (20, 21) and the inner wall of the groove (23, 24) are bent essentially concentrically to the central axis of rotation (10) and are located at approximately equal distance from the axis of rotation (10) if the clearance of motion is taken into account.

The rotary parts (5, 6) with their bearing surfaces (17) lie on one another in the operating position of the closure (4), the collar (20) of one rotary part (5) meshing with the groove (24) of the other rotary part (6) in a positive-locking manner on one side of the bearing surfaces (17). On the other side of the bearing surface (17), the collar (21) of the other rotary part (6) meshes with the corresponding groove (23) of one rotary part (5). This meshed position is illustrated by FIG. 1.

As is illustrated in FIG. 3, there is, in all operating positions (29), at least partial overlap and consequently a positive-locking guiding between the collars (21) and the grooves (23, 24), which prevents the pivot bearing (13) and the closure parts (5, 6) from loosening in the direction of the axis of rotation (10). Due to heir essentially concentrically bent shape and their radial distances from the axis of rotation (10), the collars (20, 21) and the grooves (23, 24) can rotate easily relative to one another.

The collar (20, 21) and the groove (23, 24) have each an arc angle of less than 90°. The arc angle α of the grooves (23, 24) is greater than that of the collars (20, 21) and preferably equals about 85°. The arc angle at the collar (20, 21) is even smaller.

As is illustrated by FIGS. 4, 6 and 10, the collar (20, 21) extends only over a partial area each of the width of the closure part (5, 6) and is shortened on one side while a step (22) is formed. In the top view of the exposed bearing surface (17), the step (22) is located on the right-hand side. The area of the body adjoining the setback step (22) is bent concentrically to the axis of rotation (10). This curvature also continues in the area of the body located beneath the projecting collar (20, 21).

The front side of the collar (20, 21) has a concentric curvature about the axis of rotation (10) in the area starting from the left-hand side of the closure part and extending up to the central axis (35). In the adjoining area from the central axis (35) to the step (22), the curvature may be greater and the radius of curvature smaller. As a result, a kind of lift curve is created to facilitate sliding into the groove (23, 24).

The groove (23, 24) likewise extends only over a partial area of the width of the closure part and has a lateral groove offset (32) on a side opposite the edge of the closure part. FIGS. 6 and 9 show this design. The step (22) and the groove offset (32) are located here on the same side of the bearing surface (17).

FIG. 4 shows, furthermore, that the groove (23, 24) has a variable overlap due to the body edge of the rotary part (5, 6). The edge of the body located above the bearing surface (17) first ends flush with the groove offset (32) in the upward direction on the right-hand side according to FIG. 4 and extends, starting herefrom, essentially at right angles to the central axis (35) in a straight line. The vertical wall of the body forms a preferably flat stop (34) in this area for the side wall of the respective other rotary part (5, 6). Due to the concentric shape of the groove, the overlap of the body or the groove depth progressively increases in this area. Beginning from the central axis (35), the vertical wall of the body extends in an arc up to the lateral edge of the rotary part (5, 6). As a result, the wall of the body forms an axial excess height or projection, which corresponds to the step (22) of the corresponding collar (20) in the loosened position (30). FIG. 12 shows this design. In the loosened position, the curved projection (31) conforms to the correspondingly curved front wall of the body in the area of the step.

Due to this shape, the rotary parts (5, 6) are guided in lateral contact with one another in the loosened position (30) when the tongue-and-groove guide (19) is opened and can be moved relative to one another in the direction of the axis of rotation (10) to open the closure (4) and can be moved away from one another for opening. Due to this one-sided shape of the steps (22) and projections (31), the rotary parts (5, 6) have only one loosened position (30) and angular position, which is shown in FIG. 12. In case of rotation in the opposite direction, the rotary parts (5, 6) are in contact with the projections (31) with their lateral body wall, and an overlap of the tongue-and-groove guide (19) is still present in this contact position and it prevents the closure (4) from opening.

As is illustrated in FIGS. 8, 9 and 11, the rotary parts (5, 6) with their body (25) have a cross section that is largely concentric to the central longitudinal axis (35). The rear area with the drag bearing (26, 27) is an exception. The body (25) is made thinner here in order to fit the receiving fork of the pivoted parts (7, 8). The pivoted parts (7, 8) are in turn essentially concentric to the central longitudinal axis (35).

Edge bevels may be present at the collar (20, 21) and the grooves (23, 24) in order to avoid jamming during motion. Slopes, which are favorable for motion, may also be present at the body (25) of the rotary parts (5, 6) and at the pivoted parts or fork heads (7, 8).

Various modifications of the embodiment shown are possible. The closure (4) may have, e.g., only two rotary parts (5, 6) and a pivoted part (7), in which case one cable end (3) is connected directly to the correspondingly shaped rotary part (6). The closure (4) has only two axes (10, 11) in this embodiment. This arrangement may, of course, also be reversed in a mirror-like manner.

In another variant, the closure (4) may have more than four parts (5, 6, 7, 8) and more than three axes (10, 11, 12). Furthermore, it is possible to select another shape for the pivot bearing (13) and the bearing securing means (18). The bearing securing means (18) also does not have to be present, as in the exemplary embodiment being shown, directly between the rotary parts (5, 6), but it may be present between one rotary part (5, 6) and the bearing pin (14). The rotary parts (5, 6) may, moreover, have, at least partially, a fork-shaped design and more than one bearing surface (17).

While specific embodiments of the invention have been shown and described in detail to illustrate the application of the principles of the invention, it will be understood that the invention may be embodied otherwise without departing from such principles.

1. A closure for cables comprising:
a plurality of bearings;
a plurality of closure parts connected to one another movably about at least two separate axes by means of said plurality of bearings; and
a bearing securing means wherein two of said closure parts provided with a separable pivot bearing of said plurality of bearings and said bearing securing means can be detached as a function of an angular position of the closure parts.

2. A closure in accordance with claim 1, bearing securing means comprises a mutual tongue-and-groove guide at said closure parts.

3. A closure in accordance with claim 2, wherein said bearing securing means is closed in operating positions of the closure parts in which they are aligned with one another or are mutually bent in relation to one another to a limited extent and can be loosened in a loosened position with an approximately 90° bending angle of the closure parts.

4. A closure in accordance with claim 2 wherein said double tongue-and-groove guide is arranged at the closure parts.

5. A closure in accordance with claim 2, wherein the tongue-and-groove guide is bent about the axis of the pivot bearing.

6. A closure in accordance with claim 1, wherein the pivot bearing is designed as a pivot bearing that can be plugged in, in the axial direction.

7. A closure in accordance with claim 1, wherein the closure parts have a flat bearing surface and a central bearing pin passing through the bearing surfaces to form the pivot bearing with pin.

8. A closure in accordance with claim 1, wherein the closure parts have an essentially identical design.

9. A closure in accordance with claim 1, wherein the closure parts have a stepped body.

10. A closure in accordance with claim 1, wherein the closure part at the front edge of the bearing surface has a projecting, bent collar to form the tongue.

11. A closure in accordance with claim 10, wherein the closure part the rear edge of the bearing surface has a bent groove to receive the tongue.

12. A closure in accordance with claim 11, wherein the collar and the groove are bent essentially concentrically about the axis of rotation.

13. A closure in accordance with claim 11, wherein the collar and the groove have an arc angle smaller than 90°.

14. A closure in accordance with claim 11, wherein the collar extends over a partial area of the width of the closure part and is shortened on one side and a step is formed.

15. A closure in accordance with claim 11, wherein the groove extends over a partial area of the width of the closure part and is offset in relation to the edge of the closure part on one side.

16. A closure in accordance with claim 15, wherein the step and the groove offset lie on the same side of the bearing surface.

17. A closure in accordance with claim 15, wherein the groove has a variable overlap, due to the superjacent body edge of the closure part, with an, essentially straight stop area and with a bent projection.

18. A closure in accordance with claim 11, wherein four or more said closure parts are provided connected in an articulated manner to form a multiple joint with a cardan-like arrangement of three or more axes.

19. A closure in accordance with claim 1, wherein said closure parts include end-side closure parts connected to the cable ends.

20. A process for connecting and opening cables with a multipart closure, which is movable by means of a plurality of so bearings about at least two said separate axes the process comprising the steps of:
connecting two said closure parts of the closure to one another; and
separating the closure parts by means of a separable pivot bearing, wherein a detachable bearing securing means is actuated as a function of the angular position of the closure parts.

21. A process in accordance with claim 20, wherein to connect and open the cable, the closure parts are brought into a mutual angular position and said loosened position of about 90° and are moved relative to one another along the axis of rotation of the pivot bearing.
